(19) United States
(12) Patent Application Publication
(10) Pub. No.: US 2018/0313079 A1
(43) Pub. Date: Nov. 1, 2018

(54) Multi-Layered Metalized Film For Use In Agriculture

(71) Applicant: Robert D. Russell, Arlington, TX (US)

(72) Inventor: Robert D. Russell, Arlington, TX (US)

(21) Appl. No.: 15/963,902

(22) Filed: Apr. 26, 2018

Related U.S. Application Data
(60) Provisional application No. 62/490,203, filed on Apr. 26, 2017.

(51) Int. Cl. E04B 1/78; B32B 3/26; B32B 5/02; B32B 27/08; B32B 27/32; B32B 27/36; B32B 27/12; E04B 1/76; A01K 1/00

(52) U.S. Cl. CPC E04B 1/78; E04B 2001/742; B32B 5/024; B32B 27/08; B32B 27/32; B32B 27/36; B32B 27/12; E04B 1/762; A01K 1/0047; B32B 2255/02; B32B 2255/26; B32B 2255/10; B32B 2262/0253; B32B 2307/304; B32B 2307/416; B32B 2255/205; B32B 2410/00; B32B 3/266

(57) ABSTRACT

A multi-layered metalized film for agricultural use comprising a reflective layer that comprises a metalized polyester film, acrylic polyurethane applied to the surface of the reflective layer, a bonding agent comprising a white-colored polyethylene material and a hindered amine light stabilizer that comprises a two and one-half percent ultraviolet light inhibitor, a fabric layer comprising a high density polyethylene woven fabric and an hindered amine light stabilizer, and a fabric layer coating applied to the surface of the fabric layer, the fabric layer coating comprising a white polyethylene coating material and an hindered amine light stabilizer.

### CROSS-REFERENCE TO RELATED APPLICATIONS

Applicant claims priority to U.S. Provisional Patent Application No. 62/490,203, filed Apr. 26, 2017, the disclosure of which is incorporated by reference herein in its entirety.

### DESCRIPTION OF THE DRAWINGS

FIG. 1 is a perspective view of a multi-layered metalized film, comprising an embodiment of the present invention;

FIG. 2 is a cross-section view of Section 2-2 in FIG. 1;

FIG. 3 is a perspective view of a multi-layered metalized film having a plurality of perforations therein, comprising an embodiment of the present invention;

FIG. 4 is a perspective view of a building wherein an embodiment of the present invention is being installed underneath the roof panels of the building;

FIG. 5 is a magnified view of the box shown in FIG. 4 wherein an embodiment of the present invention is attached to the underside of a roof via an adhesion; and

FIG. 6 is a magnified view of the box shown in FIG. 4 wherein an embodiment of the present invention is attached to the underside of a roof via a plurality of screws.

### BACKGROUND OF THE INVENTION

Heat is an indispensable effect of the functioning of the natural world. It results because of the energy transfer between two materials. As such, it is a byproduct of energy. There are three main types of heat, also known as thermal energy transfer: conduction, convention and radiation.

One type thermal energy transfer, radiation, is the direct result of random movements of atoms and molecules in matter, which results in the emission of electromagnetic waves. An example of radiation is visible light. Sunlight is thermal radiation generated by the hot plasma of the sun and is comprised of the visible light spectrum as well as infrared and ultraviolet energy. When radiation energy reaches a surface, the energy is absorbed by the surface, transmitted through the surface and/or reflected by the surface.

Energy transferred via radiation to the skin of living beings, such as livestock and the like, constitutes a major part of the thermal stress experienced by such livestock. This heat gained from radiation imposes a strain on the body of livestock and other similar farm animals. High ambient temperature, relative humidity and radiant energy compromise the ability of livestock to dissipate heat within their bodies. As a result, there is an increase in body temperature, which, in turn, initiates adaptive mechanisms to re-establish homeothermy and homeostasis. It is well-documented that heat stress affects not only an animal's well-being but also its production. Specifically, there is a significant decline in animal performance when subjected to heat stress. The effects of heat stress is evident in feed consumption, production efficiency such as in milk yields or weight gain per unit of feed energy, growth rate, egg production and reproductive efficiency. Changes in behavior, disease and even death can occur.

The heat experienced by livestock cannot be fully appreciated by only considering the ambient air temperature of where livestock is located, using a dry bulb thermometer. This is because a dry bulb thermometer measures only the temperature of the ambient air that is shielded from direct rays of the sun and does not measure other sources that emit radiant energy. Thus, the full amount of radiation heat being transferred to livestock is not considered. To more appreciate the radiant heat affecting livestock, a black globe thermometer should be use utilized. A black globe thermometer measures the heat that results from the radiant energy being transferred to the livestock from sunlight and from other sources.

Because the heat transferred by radiant energy is not fully appreciated using dry bulb thermometers, the air temperature that is reported by dry bulb thermometers does not accurately reflect the amount of heat that livestock may be experiencing. This phenomenon is called the “black-globe effect.” Because of the black-globe effect, the real temperature experienced by livestock may be ten to twenty degrees Fahrenheit greater than that reported by dry bulb thermometers. Consequently, for example, whether an animal is outdoors or indoors, the animal may experience heat associated with air temperatures approaching eighty-eight or ninety-eight degrees Fahrenheit even though the actual air temperature may be seventy-eight degrees Fahrenheit. Thus, the animal experiences greater heat and heat stress, which, in turn, decreases production efficiency.

In addition to the black-globe effect, livestock is also exposed to a hazardous form of radiation in the nature of ultraviolet light. Excessive exposure to ultraviolet light can cause cancer in animals and can damage their eyesight. While an animal's fur can protect most of its body from direct exposure to the damaging rays, ultraviolet radiation may damage the unprotected body parts, such as the nose, paws, muzzle and other furless parts.

While insulation could potentially assist in decreasing the heat stress experienced by livestock, typically structures for agricultural use, such as barns and chicken coops, are not insulated because installing and maintaining the insulation is not cost-effective and because insulation would also likely require an air conditioning system to control the climate, which is also not cost-effective. Conventional insulation systems and materials are not weatherproof and, therefore, do not fare well for use in agriculture.

What is needed is a device for use in agriculture that aids in reducing the heat stress of livestock. More specifically, what is needed is a device for use in agriculture that can be installed and used in buildings in a cost-effective manner and that reduces the radiation energy entering the buildings via sunlight and other sources, thereby reducing the heat stress of the livestock, which, in turn, increasing livestock production efficiency.

A multi-layered metalized film for agricultural use, having a plurality of embodiments disclosed herein, is a novel invention that meets the needs that are described in the aforementioned paragraphs, while also providing many substantial advantages such as, but not limited to, reducing radiant energy, the black-globe effect, heat and heat stress while increasing agricultural production efficiency as well as cost efficiency.

An embodiment of the present invention comprises a film having a plurality of layers and/or coatings to reflect radiation and, therefore, reduce heat in agricultural environments. Specifically, the film can comprise an outer layer/coating, a reflective layer, a poly layer, a fabric layer and an inner layer/coating. The layers/coatings are sandwiched together to form one flexible material (i.e., film/insulation). The film/insulation is suitable for installation in a building, such as a barn, chicken coop, poultry house, cow shed, hog pen, stable, etc.

Another embodiment of the present invention can comprise a plurality of the aforementioned layers/coatings sandwiched together in a flexible material (i.e., film) wherein the material comprises a plurality of perforations therein to permit the migration of air and fluids to pass therethrough, without acting as a vapor barrier.

In addition to reducing and/or reflecting radiation, the present invention can reflect electromagnetic waves of frequencies that lie in the range of 20 kHz to 300 GHz, roughly the frequencies used in radio communication, also know as radio frequencies (RF). Thus, the present invention can act as radio frequency shielding. Consequently, it can prevent RF signals from substantially penetrating the material that comprise the present invention or from competing with one another.

While the present invention can be utilized in a variety of context, its primary application is the roof and other areas of buildings that are used in agriculture. As such, embodiments of the present invention can be installed on top as well as the sides of buildings. Furthermore, embodiments are weatherproof and not susceptible to water damages. Also, they increase reflected lighting in the agricultural building and reduce dirt buildup on interior surfaces of the building.

### DETAILED DESCRIPTION

While the assembly of the present application is susceptible to various modifications and alternative forms, specific embodiments thereof are shown by way of example in the drawings and are herein described in detail. It should be understood, however, that the description herein of specific embodiments is not intended to limit the invention to the particular embodiment disclosed, but on the contrary, the intention is to cover all modifications, equivalents and alternatives falling within the spirit and scope of the present application.

Illustrative embodiments of the insulation for agricultural use of multi-layered metalized film are provided below. It will, of course, be appreciated that in the development of any actual embodiment, numerous implementation-specific decisions will be made to achieve the developer's specific goals, such as compliance with assembly-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

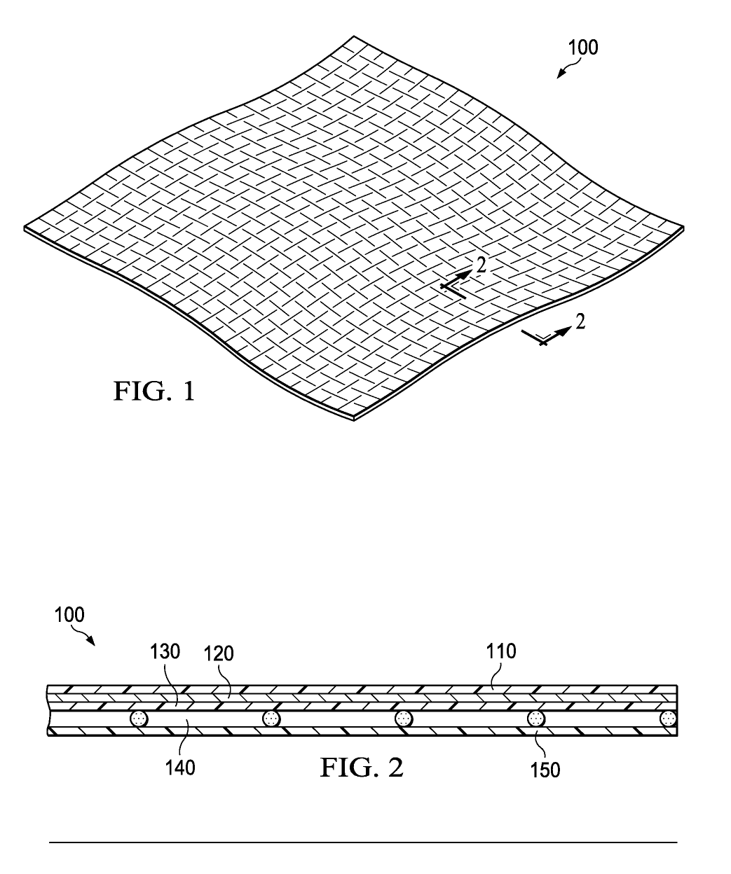

Turning now to FIG. 1, an illustration is shown that depicts a multi-layered metalized film 100, which is an embodiment of the present invention. The film 100 as shown is a sheet, which can be cut to desired dimensions lengthwise and widthwise. Ideally, the thickness of the film 100 is between six (6) to twelve (12) microns. The film 100 is comprised of a plurality of layers and/or coatings to reduce/reflect radiation, thereby reducing the heat stress experienced by livestock and, in turn, increasing the production efficiency of livestock.

FIG. 2 depicts a cross-sectional view of the film 100 of FIG. 1 at Section 2-2. FIG. 2 shows the layers and/or coatings, which comprise the film 100. As shown, the film 100 comprises an outer layer/reflective layer coating 110, a reflective layer 120, poly layer/bonding agent 130, a fabric layer 140 and an inner layer/fabric layer coating 150. The layers/coatings are sandwiched together to form one flexible material that is suitable for installation in a building such as, without limitation, a barn or the like.

The outer layer 110 can be a separate layer from the reflective layer 120, or preferably a reflective layer coating applied to the surface of the reflective layer 120 to aid in the resistance of corrosion. The reflective layer coating, which is comprised of Acrylic Polyurethane, has a preferred thickness of fifteen one-hundredth (0.15) grams per square meter.

The reflective layer 120 is preferably a metal poly material that is reflective and formed from aluminum and polyethylene, such as, but not limited to, metalized polyester film. The reflective layer 120 has a preferred thickness of eight (8) microns.

The poly layer/bonding agent 130 is preferably a layer of white-colored polyethylene material, a bonding agent to ensure the bonding of the layers together, and is typically chemically treated to resist the effects of ultraviolet light. The poly layer/bonding agent 130 comprises a two and one-half percent ultraviolet light inhibitor, which is a Hindered-amine light stabilizer, an amine ether derivative of tetramethylpiperidine. The poly layer/bonding agent 130 has a preferred thickness of nineteen (19) grams per square meter.

The fabric layer 140 is comprised of high density polyethylene woven fabric (i.e., a fabric scrim) that provides structural support for the film 100 and is typically chemically treated to resist the effects of ultraviolet light. As such, the fabric layer 140 comprises a two and one-half percent ultraviolet light inhibitor, which is a Hindered-amine light stabilizer, an amine ether derivative of tetramethylpiperidine material. The fabric layer 140 has a preferred thickness of seventy (70) grams per square meter.

The inner layer/fabric layer coating 150 can be a separate layer from the fabric layer 140, or preferably a white polyethylene coating applied to the surface of the fabric layer 140 to aid in the resistance of corrosion. The inner layer/fabric layer coating 150 comprises a two and one-half percent ultraviolet light inhibitor, which is a Hindered-amine light stabilizer, an amine ether derivative of tetramethylpiperidine material. The inner layer/fabric layer coating 150 has a preferred thickness of twenty-five (25) grams per square meter. It should be noted that all polyethylene components described herein contain a two and one-half (2.5) percent ultraviolet (UV) inhibitor, which is a Hindered-amine light stabilizer, an amine ether derivative of tetramethylpiperidine material.

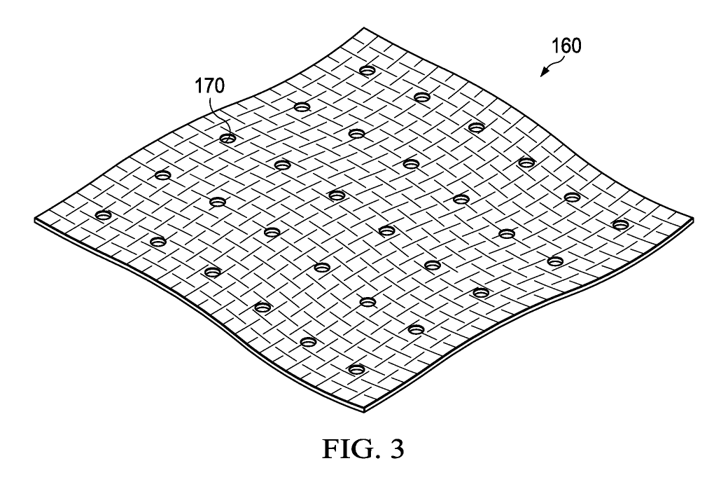

FIG. 3 illustrates another embodiment of the present invention wherein a multi-layered metalized film 160 comprises the layers/coatings as described above that comprise the multi-layered metalized film 100, but the multi-layered metalized film 160 comprises a plurality of perforations 170. The perforations 170 are apertures in the film 160 that pervade all the layers/coatings therein, thereby permitting air and liquids to pass therethrough, so that the film 160 is not a vapor barrier. The embodiment of the present invention of film 100 can be considered a vapor barrier, whereas the embodiment of the present invention of film 160 is not.

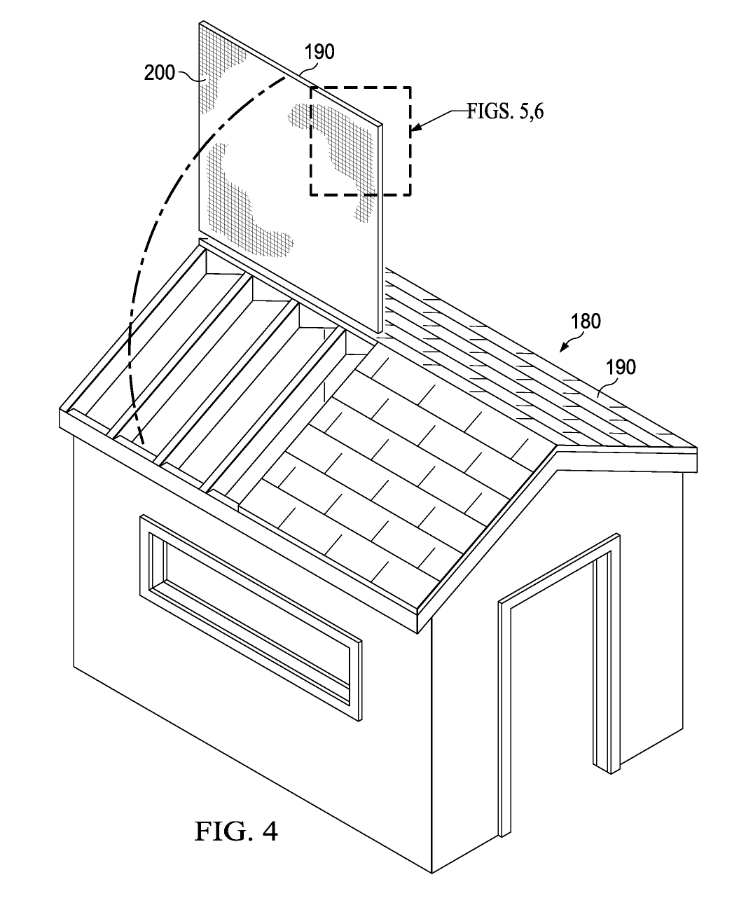

Turning to FIG. 4, a use of an embodiment of the present invention is shown. FIG. 4 depicts a building 180 with a roof 190. It should be appreciated by a person of ordinary skill in the art that the building 180 can be any type used for agriculture, such as, but not limited to, a barn, chicken coop, poultry house, cow shed, hog pen or stable, the roof 190 can be any type, such as, but not limited to, gable, hip, mansard, gambrel, flat, skillion, etc., and the roofing shingle can be any type, such as, but not limited to, asphalt shingles, tiles, wood shingles, metal roofing, slate, etc. Preferably, an embodiment of the present invention is installed underneath the roof panels and/or inside of the wall siding. However, it should be understood that an embodiment may be installed in any portion of a building—whether it be the interior or exterior. FIG. 4 shows an embodiment of the present invention 200 (i.e., the film) installed underneath of and attached to the roof 190 of the building 180.

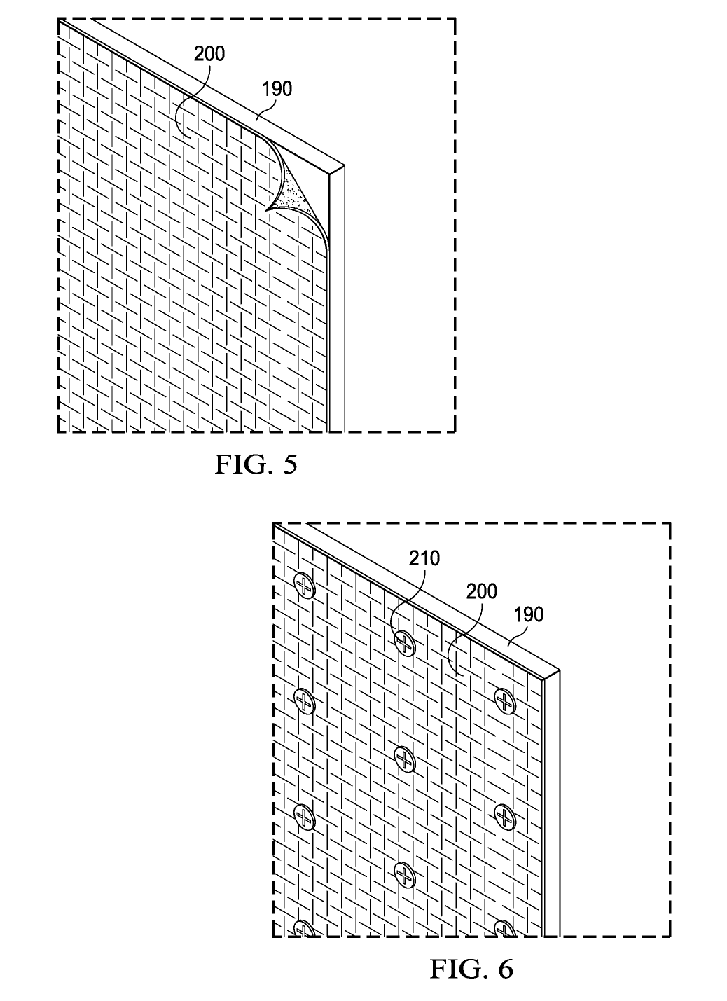

FIGS. 5 and 6 show examples of how an embodiment of the present invention can be attached to the roof 190 of the building 180. FIG. 5 depicts an embodiment of the present invention 200 attached to the roof 190 via an adhesive whereas FIG. 6 depicts an embodiment of the present invention 200 attached to the roof 190 via a plurality of screws 210. However, persons of ordinary skill in the art will appreciate that an embodiment of the present invention 200 can be attached to the roof 190 in a variety of ways that are known in the art and the methods/ways shown herein are for purposes of example only.

It is apparent that a film with significant advantages has been described and illustrated herein. The particular embodiments disclosed herein are illustrative only, as the embodiments may be modified and practiced in different but equivalent manners apparent to those skilled in the art having the benefit of the teachings herein. It is, therefore, evident that the particular embodiments disclosed herein may be altered or modified, and all such variations are considered within the scope and spirit of the present invention.

Although many embodiments of the present invention have been illustrated in the accompanying Drawings and described in the foregoing Detailed Description, it should be understood that the present invention is not limited to the embodiments disclosed, but is capable of numerous rearrangements, modifications, and substitutions of parts and elements without departing from the spirit of the invention.

What is claimed is:

1. A multi-layered metalized film for agricultural use, the film comprising:
a reflective layer comprising reflective material;
a reflective layer coating applied to the surface of the reflective layer to aid in the resistance of corrosion;
a bonding agent for ensuring that the layers of the film maintain a bond together so as to form one flexible material and wherein the bonding agent comprises a hindered amine light stabilizer that comprises a two and one-half percent ultraviolet light inhibitor;
a fabric layer for providing structural support to the film wherein the fabric layer comprises a hindered amine light stabilizer that comprises a two and one-half percent ultraviolet light inhibitor; and
a fabric layer coating applied to the surface of the fabric layer to aid in the resistance of corrosion wherein the fabric layer coating comprises a hindered amine light stabilizer that comprises a two and one-half percent ultraviolet light inhibitor.

2. The film of claim 1 wherein the reflective material is a metalized polyester film.

3. The film of claim 2 wherein the metalized polyester firm has a thickness of 8 microns.

4. The film of claim 1 wherein the reflective layer coating is Acrylic Polyurethane.

5. The film of claim 4 wherein the Acrylic Polyurethane has a thickness of 0.15 grams per square meter.

6. The film of claim 1 wherein the bonding agent is constructed of white-colored polyethylene.

7. The film of claim 6 wherein the white-colored polyethylene has a thickness of 19 grams per square meter.

8. The film of claim 1 wherein the fabric layer is a high density polyethylene woven fabric.

9. The film of claim 8 wherein the high density polyethylene woven fabric has a thickness of 70 grams per square meter.

10. The film of claim 1 wherein the fabric layer coating is a white polyethylene coating.

11. The film of claim 10 wherein the white polyethylene coating has a thickness of 25 grams per square meter.

12. The film of claim 1 wherein the film defines a plurality of perforations, thereby permitting air and liquids to pass through the film.

13. The film of claim 12 wherein the reflective material is a metalized polyester film.

14. The film of claim 13 wherein the reflective layer coating is Acrylic Polyurethane.

15. The film of claim 14 wherein the bonding agent is constructed of white-colored polyethylene.

16. The film of claim 15 wherein the fabric layer is a high density polyethylene woven fabric.

17. The film of claim 16 wherein the fabric layer coating is a white polyethylene coating.

18. A multi-layered metalized film for agricultural use, the film comprising:
a reflective layer comprising a metalized polyester film;
an acrylic polyurethane coating applied to the surface of the reflective layer to aid in the resistance of corrosion;
a bonding agent for ensuring that the layers of the multi-layered metalized film maintain a bond together so as to form one flexible material, the bonding agent comprising white-colored polyethylene and an hindered amine light stabilizer;
a fabric layer for providing structural support to the film, the fabric layer comprising a high density polyethylene woven fabric and an hindered amine light stabilizer; and
a fabric layer coating applied to the surface of the fabric layer to aid in the resistance of corrosion, the fabric layer coating comprising a white polyethylene coating material and an hindered amine light stabilizer.
